(19) United States
(12) Patent Application Publication
(10) Pub. No.: US 2012/0056386 A1
(43) Pub. Date: Mar. 8, 2012

(54) MULTILAYER SEALING RING

(76) Inventor: Klaus Schmitt, Grunebach (DE)

(21) Appl. No.: 13/320,578

(22) PCT Filed: Feb. 8, 2010
(86) PCT No.: PCT/EP2010/051465

§ 371 Date: Nov. 15, 2011

(30) Foreign Application Priority Data
May 15, 2009 (DE) 10 2009 021 504.2

(51) Int. Cl. F02F 11/00; F16J 15/02

(52) U.S. Cl. 277/594

(57) ABSTRACT

A sealing ring for components of an internal combustion engine, with a first and a second axial sealing zone, includes an inner closed ring with a V-shaped cross-section, and an outer closed ring with a V-shaped cross-section. The open side of the outer closed ring points in the same direction as that of the inner ring.

The present invention relates to a V sealing ring, in particular for turbochargers and exhaust systems of internal combustion engines, having more than one layer.

Currently, V sealing rings are conventionally produced from a single-walled ring. Such rings having a V-shaped cross-section are usually used as seals on turbochargers and exhaust systems. Such rings exist without a weld seam, but the rings are generally welded. They conventionally consist of a comparatively hard material.

The sealing rings are shaped both with the open side of the V shape towards the interior and also towards the exterior. Various materials, such as for example Inconell, 1.4828 etc. are used.

In the region of the sealing zone, leakages can occur due to the weld seam or else due to an insufficient adaptation behaviour to the component which is to be sealed, owing to the hard material. Producing known single-walled sealing rings from a high-grade material requires a great material input.

It is therefore an object of the invention to provide a sealing ring which has improved sealing characteristics, has a higher quality and which can be produced with a reduced input of high-grade materials.

According to an aspect of the invention, a sealing ring is provided, in particular for components of an internal combustion engine, with a first and a second axial sealing zone, comprising
an inner closed ring with a V-shaped cross-section; and
an outer closed ring with a V-shaped cross-section, the open side of which points in the same direction as that of the inner ring.

In the sealing ring according to the invention, two or more rings are nested into each other. By the use of several rings, a labyrinth effect is achieved, which increases the sealing quality. The rings lie against each other, wherein the open side of the V shape points respectively either inwards or outwards.

According to an embodiment, the sealing ring further comprises:
one or more closed intermediate rings with a V-shaped cross-section, arranged between the inner ring and the outer ring, wherein the open side points in the same direction as that of the inner and outer ring.

To improve the sealing characteristics, more than two rings can be used.

According to an embodiment, the outer ring consists of a softer material than that of the inner ring.

By the use of a softer material for the outer ring, the adaptation behaviour and hence the sealing quality can be improved. The inner ring provides for the necessary stability, whereas the outer ring ensures a better adaptation.

According to an embodiment, the outer ring consists of non-thermosetting material and the inner ring consists of a thermosetting material.

Through this combination of material, after the construction of the V shape the sealing ring can be subjected to a thermal treatment, whereby the inner ring hardens whereas the outer ring becomes soft.

According to an embodiment, the sealing ring is profiled and/or coated in at least one of the sealing zones.

By the additional profiling and/or coating, the sealing can be improved. Preferably the outer ring is profiled and/or coated, but basically each of the V rings can have a profiling and/or coating.

According to an embodiment, at least one V-shaped ring differs in material thickness and/or material from at least one of the other V-shaped rings.

By the choice of the type of material and/or material thickness, the characteristics of the sealing ring according to the invention can be set accordingly. The resulting gap on the periphery between respectively two V rings can be increased or reduced by the choice of the gauge or respectively thickness of the individual rings. Likewise, the elasticity of the respective V rings can be controlled by the choice of the gauge.

The material choice makes possible, inter alia, the setting of the adaptation behaviour (harder/softer). By the use of several V rings, high-grade and expensive material can be used in a more targeted manner and to a lesser extent only where (for example on the inner ring) it is necessary, whilst a portion of the V rings which are used (for example the inner ring or the intermediate rings) can be produced from more favourable material without, in so doing, the quality of the sealing ring according to the invention being impaired.

### BRIEF DESCRIPTION OF THE DRAWINGS

The invention is further explained below with reference to the drawings, representing example embodiments, and in which

FIG. 1 shows a first embodiment of a sealing ring according to the invention in cross-section;

FIG. 2 shows a second embodiment of a sealing ring according to the invention in cross-section;

FIG. 3 shows a third embodiment of a coated sealing ring according to the invention in cross-section;

FIG. 4 shows a fourth embodiment of a profiled sealing ring according to the invention in cross-section;

FIG. 5 shows a three-dimensional view of a sector cutout of a sealing ring according to the invention in cross-section; and

FIG. 6 shows a complete cross-section of an embodiment of the invention.

### DETAILED DESCRIPTION OF THE INVENTION

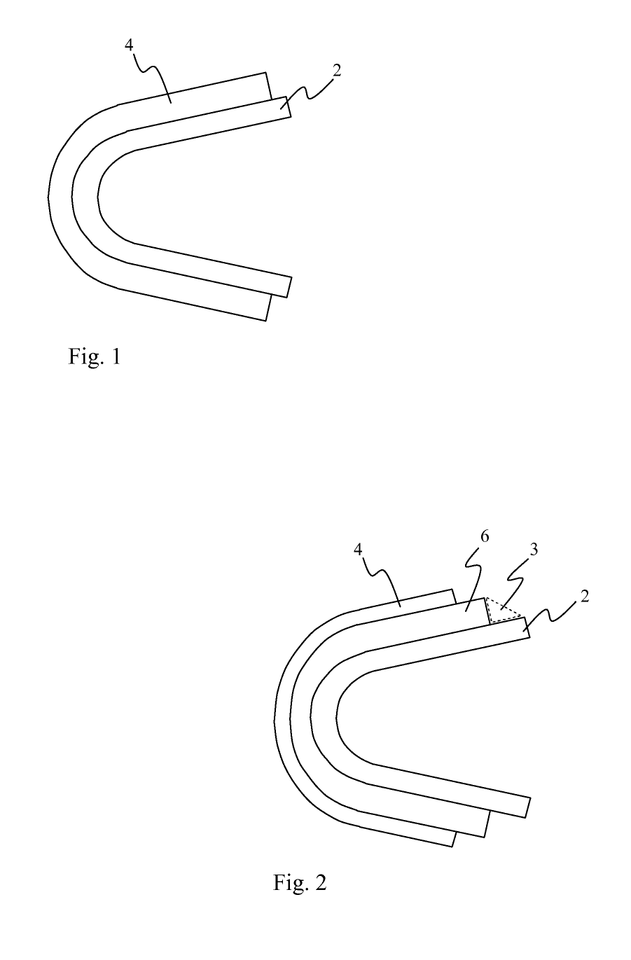

In FIG. 1 a first embodiment of the sealing ring according to the invention is shown. The sealing ring comprises an inner ring 2 with a V-shaped cross-section, and an outer ring 4 likewise with a V-shaped cross-section.

The inner ring 2 and the outer ring 4 lie against each other. Thereby, an improved sealing effect is achieved by the formation of a labyrinth effect. The open side can, as shown here, point inwards. In other words, the closed side of the outer ring 4 is situated on the outer side of the entire sealing ring, whereas the open side of the inner ring 2 is situated on the inner side of the entire sealing ring.

In alternative embodiments, however, this can also be reversed. In such embodiments, the open side of the V rings points outwards, i.e. the closed side of the outer ring is situated on the outer side of the entire sealing ring, whereas the closed side of the inner ring is situated on the inner side of the entire sealing ring.

It is to be noted that the invention is not restricted to the use of V rings, but also extends to similar shapes such as U rings, semi-circular rings and suchlike. The concern here is respectively with shapes having an open side (arranged to the right in this figure) and a closed side (arranged to the left in this figure).

In FIG. 2 an alternative embodiment of the invention is shown. This sealing ring comprises an inner ring 2, an outer ring 4 and in addition an intermediate ring 6. All the rings have a V shape and point with the open side in the same direction. Also in this figure, the variant with inwardly open V rings is shown by way of example, with the invention also extending to the reverse embodiment.

The use of more than two rings offers a more flexible possibility for adapting the type and thickness of the material of the rings, in order to achieve the desired adaptation and sealing behaviour. The material gauge also influences the gap 3 (indicated here in dashed lines) which is formed between two rings. The thinner the rings are which are involved, the smaller the gap 3. The elasticity of the corresponding ring can be set by the choice of the material.

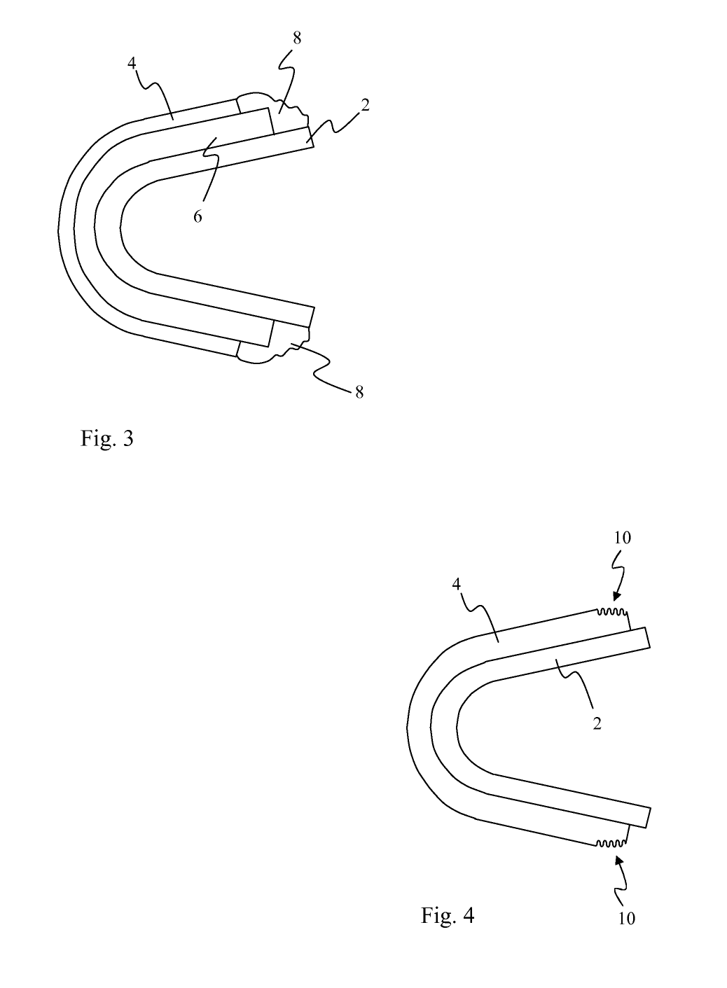

In FIG. 3 an alternative embodiment of the invention is shown. This embodiment is based on the variant shown in FIG. 2 with an inner ring 2, an outer ring 4 and an intermediate ring 6. In addition here, a coating 8 is provided, in order to improve the sealing in the axial sealing zones.

In FIG. 4 a further embodiment of the sealing ring according to the invention is shown. This embodiment constitutes an expansion of the variant shown in FIG. 1. This sealing ring likewise comprises an inner ring 2 and an outer ring 4. Both rings have a V shape and point with the open side in the same direction (inwards here, but also outwards in alternative embodiments).

In order to improve the sealing in the axial sealing zones, this sealing ring has a profiling 10.

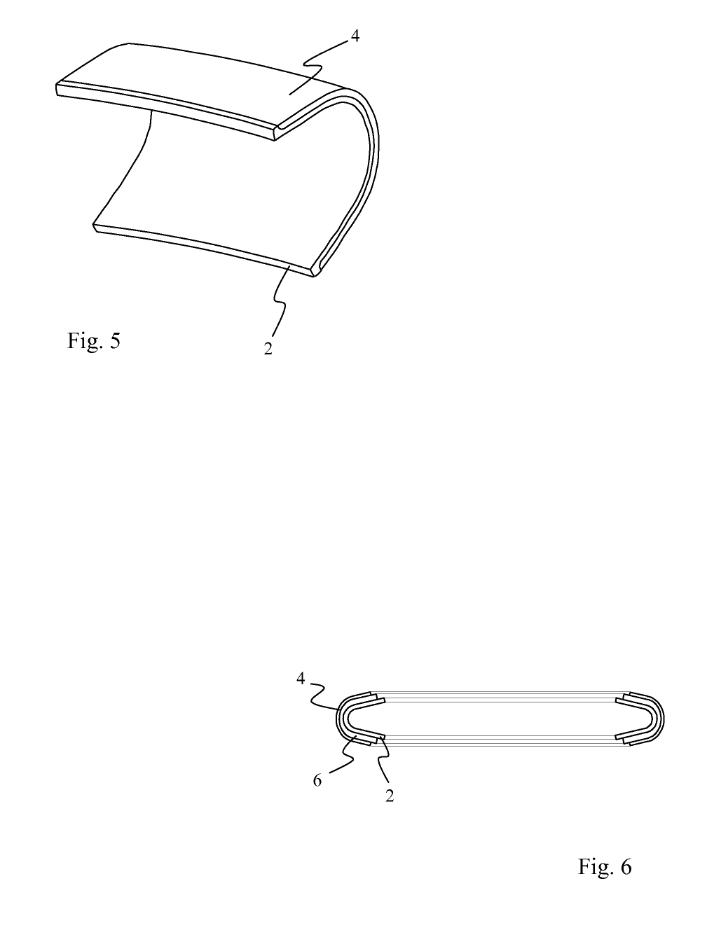

In FIG. 5 a three-dimensional view of a partial sector of a sealing ring according to the invention is shown. The sealing ring has an inner V-shaped ring 2 and an outer V-shaped ring 4. The transition region between ring 2 and ring 4 is not graduated here as in the embodiments described hitherto. Instead, the inner ring 2 also extends into the gap which is present in the embodiments described hitherto, so that as a whole a gap-free transition is produced.

In FIG. 6 an overall cross-section through a sealing ring is shown, which corresponds to that of FIG. 2.

A combination of the embodiments of FIGS. 3 and 4 is likewise possible, i.e. both a profiling and also a coating can be provided in the (or one of the or else several) sealing zones. The profiling can be arranged on the same ring(s) as the coating. Thus, for example, a sealing ring, similarly to that of FIG. 3, can be additionally provided with a profiling of the intermediate ring.

In other embodiments, a ring is (or several rings are) coated and another is (or several are) profiled. For example, in an embodiment based on FIG. 3, the coating can extend only onto the inner and the intermediate ring, whereas the outer ring is not coated, but is profiled.

Various numbers of rings (two, three or more), optional coating and optional profiling can be combined with each other as desired. The two axial sealing zones do not necessarily have to be embodied in an identical manner. Thus for example, a first sealing zone can be only coated, whereas the second sealing zone is only profiled. Also, only one sealing zone can be coated and/or profiled.

The invention also extends to embodiments with more than three rings, wherein in this case the number of intermediate rings is greater than one. The sealing ring of the invention can be shaped so as to be open both towards the interior and also towards the exterior, wherein in the above description, by way of example, only the inwardly open variant was described.

1. Sealing ring, in particular for components of an internal combustion engine, with a first and a second axial sealing zone, comprising
an inner closed ring (2) with a V-shaped cross-section; and
an outer closed ring (4) with a V-shaped cross-section, the open side of which points in the same direction as that of the inner ring (2).

2. Sealing ring according to claim 1, further comprising
one or more closed intermediate rings (6) with a V-shaped cross-section, arranged between the inner ring (2) and the outer ring (4), wherein the open side points in the same direction as that of the inner (2) and outer ring (4).

3. Sealing ring according to claim 1 or 2, wherein the outer ring (4) consists of a softer material than that of the inner ring (2).

4. Sealing ring according to one of the preceding claims, wherein the outer ring (4) consists of a non-thermosetting material and the inner ring (2) consists of a thermosetting material.

5. Sealing ring according to one of the preceding claims, wherein the sealing ring has a profiling (10) in at least one of the sealing zones.

6. Sealing ring according to one of the preceding claims, wherein the sealing ring has a coating (8) in at least one of the sealing zones.

7. Sealing ring according to one of the preceding claims, wherein at least one V-shaped ring (2, 4, 6) differs in material thickness and/or in material from at least one of the other V-shaped rings (2, 4, 6).
